(19) United States
(12) Patent Application Publication
(10) Pub. No.: US 2012/0056995 A1
(43) Pub. Date: Mar. 8, 2012

(54) Method and Apparatus for Stereo-Based Proximity Warning System for Vehicle Safety

(75) Inventors: Goksel Dedeoglu, Plano, TX (US); Andrew Miller, Sanford, FL (US)

(73) Assignee: TEXAS INSTRUMENTS INCORPORATED, Dallas, TX (US)

(21) Appl. No.: 13/222,195

(22) Filed: Aug. 31, 2011

Related U.S. Application Data
(60) Provisional application No. 61/378,785, filed on Aug. 31, 2010.
(60) Provisional application No. 61/391,859, filed on Oct. 11, 2010.

(51) Int. Cl. H04N 13/02

(52) U.S. Cl. 348/47; 348/E13.074

(57) ABSTRACT

A method and apparatus for stereo-based proximity warning system for vehicle safety. The method comprising capturing a right and a left image utilizing the right and left of stereo cameras, performing stereo analysis and depth computation for comparing and determining the depth deviation between the current depth image with the depth model, updating the depth model when there is minimal or no deviation, otherwise, performing morphological operations for clean-up and connected components analysis, and determining if the object is too close to be safe utilizing the component analysis, and generating a warning when the object is too close.

### CROSS-REFERENCE TO RELATED APPLICATIONS

This application claims benefit of U.S. provisional patent application Ser. No. 61/378,785, filed Aug. 31, 2010 and 61/391,859, filed Oct. 11, 2010, which are herein incorporated by reference.

### BACKGROUND OF THE INVENTION

1. Field of the Invention

Embodiments of the present invention generally relate to a method and apparatus for stereo-based proximity warning system for vehicle safety.

2. Description of the Related Art

Vehicles have become more intelligent utilizing various technologies. At this time, some vehicles are capable of parallel parking all by themselves and facilitating a safer ride for drivers and pedestrians. However, the current systems are not as accurate or efficient as one would like.

Therefore, there is a need for an improved method and/or apparatus for proximity warning system for vehicle safety.

### SUMMARY OF THE INVENTION

Embodiments of the present invention relate to a method and for stereo-based proximity warning system for vehicle safety. The method comprising capturing a right and a left image utilizing the right and left of stereo cameras, performing stereo analysis and depth computation for comparing and determining the depth deviation between the current depth image with the depth model, updating the depth model when there is minimal or no deviation, otherwise, performing morphological operations for clean-up and connected components analysis, and determining if the object is too close to be safe utilizing the component analysis, and generating a warning when the object is too close.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1, FIG. 2 and FIG. 3 are embodiments of depth images used to generate warnings in a back-over scenario;

FIG. 4, FIG. 5 and FIG. 6 are embodiments of depth images used to generate warnings in a front proximity scenario;

FIG. 7 is an embodiment of depth images used to generate warnings in a video security scenario;

FIG. 8 is an embodiment of depth images used in Human Device Interface for gesture based interaction;

FIG. 9 is an embodiment of images depicting interpolating missing depth pixels with the depth model;

FIG. 10 is an embodiment of a flow diagram for a method for operating a stereo-based proximity warning system for vehicle safety; and

FIG. 11 is an embodiment of a block diagram for a stereo-based proximity warning system for vehicle safety.

### DETAILED DESCRIPTION

Described herein is a depth-based detection for sensing the proximity of objects around a vehicle and generating a warning signal for safety purposes. More specifically, the depth-based detection senses objects within a predefined proximity level to the observer, which may be a useful feature in automotive.

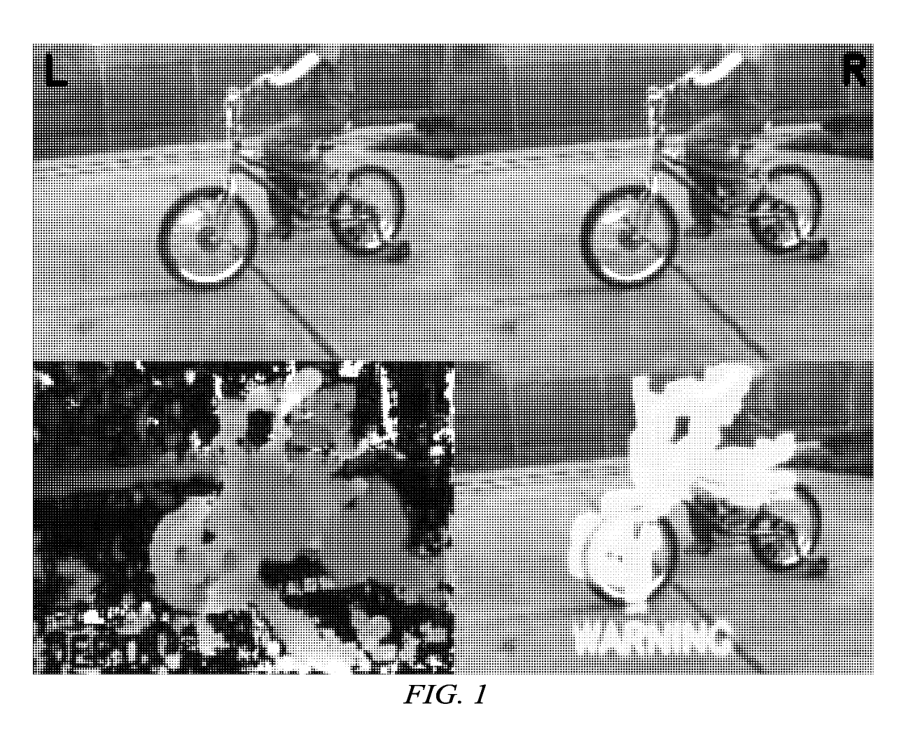

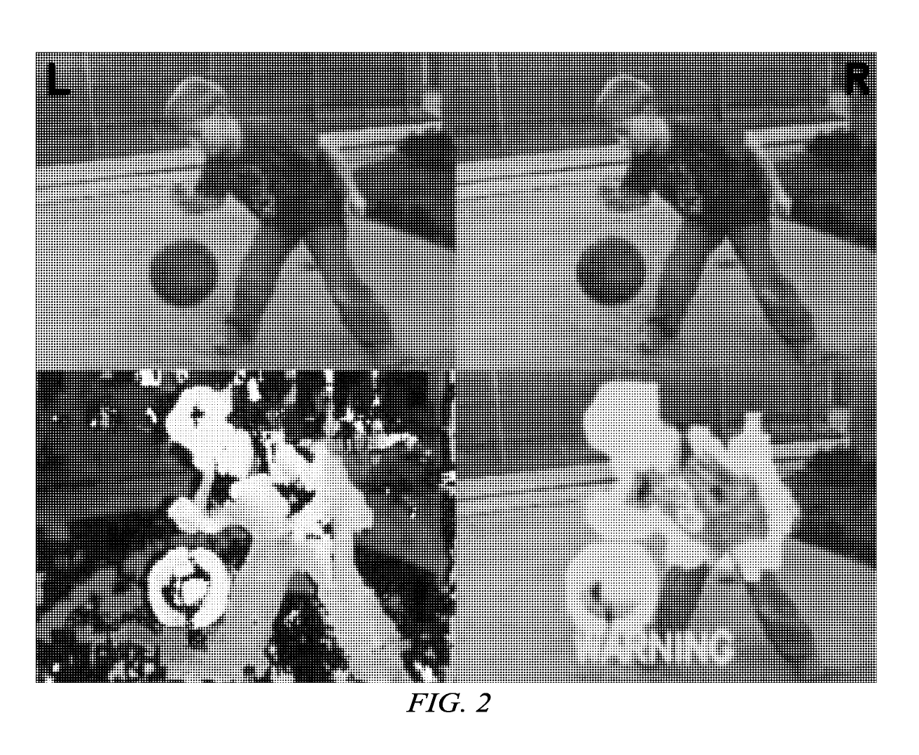

The two key components are (1) Depth-sensing: using stereo vision software to recover the depth of the scene as captured by the stereo cameras. FIG. 1-6 are embodiments of depth images used to generate warnings. (2) Analysis and filtering of the depth images to detect objects, which are within a predefined proximity level to the cameras, which will be described in detail below.

Assuming that objects of interest, such as, pedestrians, bicycles, or other vehicles, occupy a sufficient portion of the cameras' field-of-view, the stereo depth images are processed as follows:
a. Threshold the depth image. This filters out those pixels in the depth image that belong to objects farther than the set proximity threshold.
b. Compute the difference between the estimated background depth and the currently observed depth. This step filters out pixels that are close to the camera but belong to the scene, such as the ground plane.
c. Apply morphological filters, erosion and dilation, to eliminate spurious measurements.
d. Apply connected components labeling and size filtering to filter out objects smaller than a size threshold.
e. Should an object survive the above filtering mechanism, generate a warning signal. We currently communicated this to the user with a graphical overlay.
f. Maintain the background depth model. In our current implementation, we compute the mean depth, for each row, of all pixels that do not belong to the detected object.

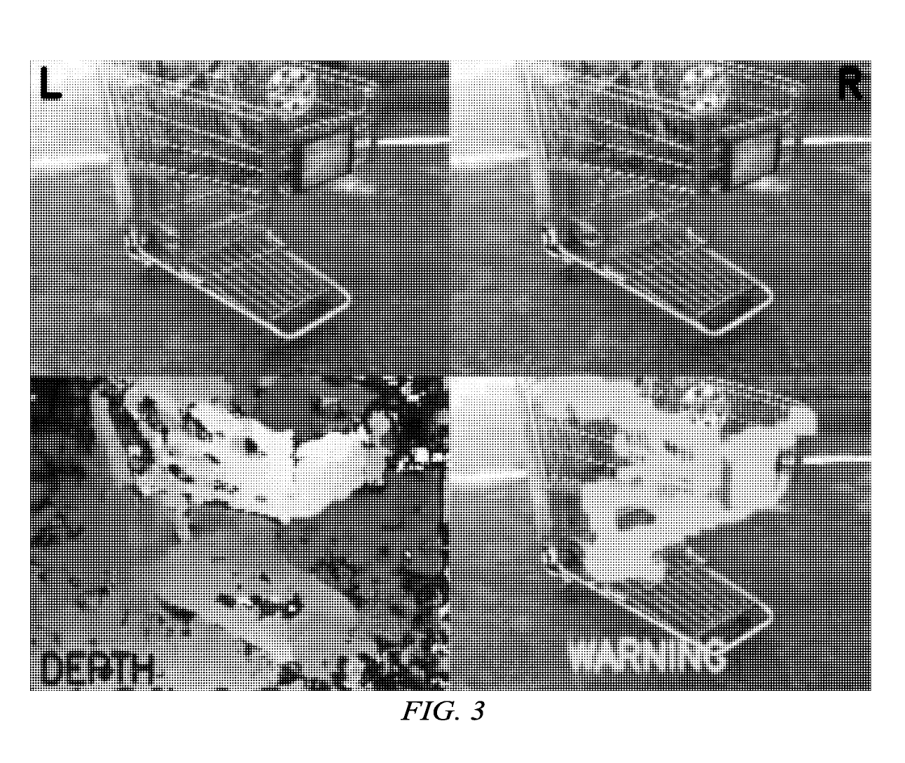

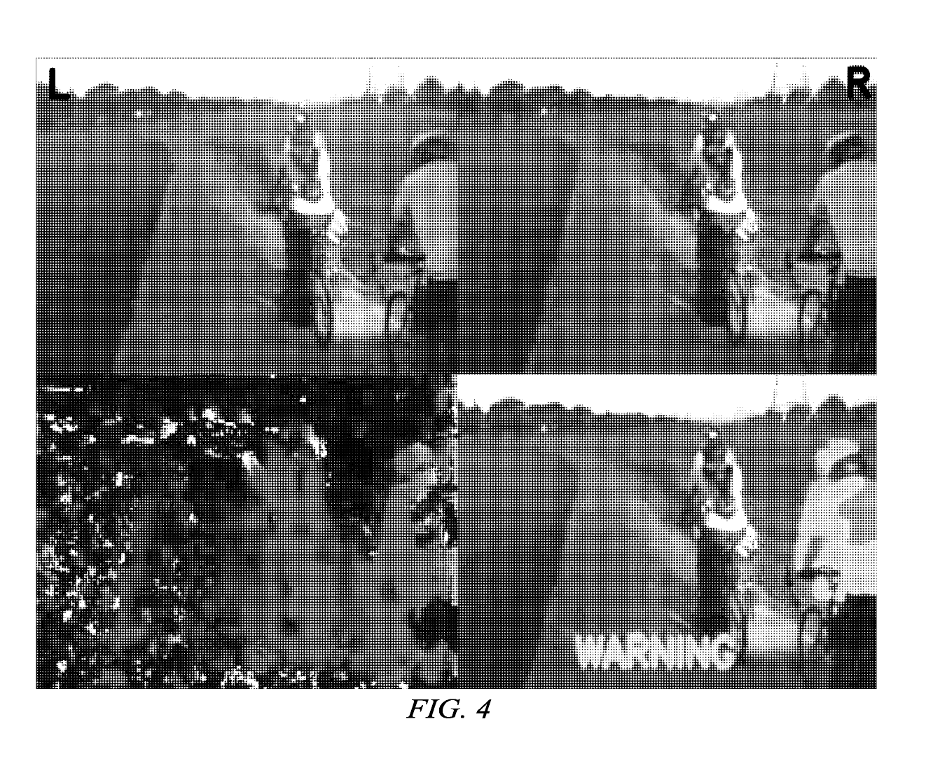

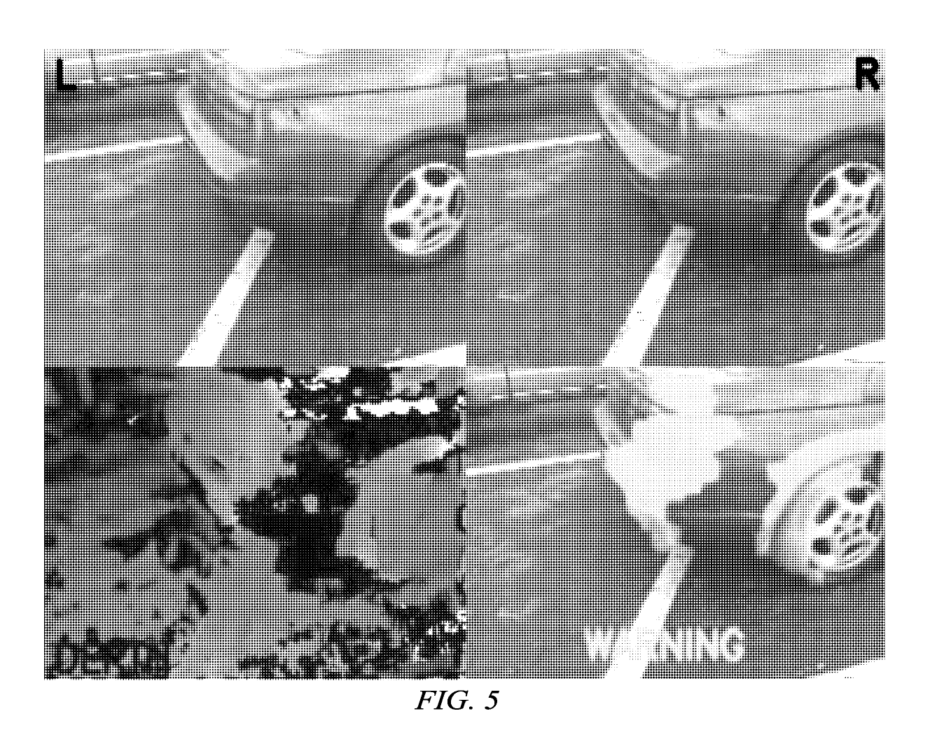

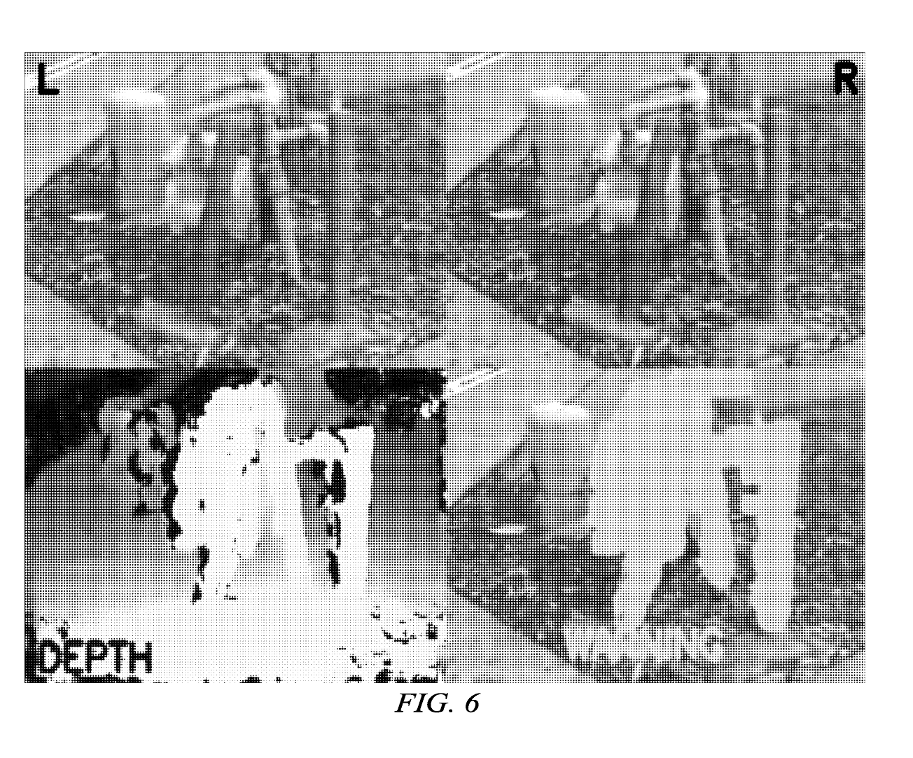

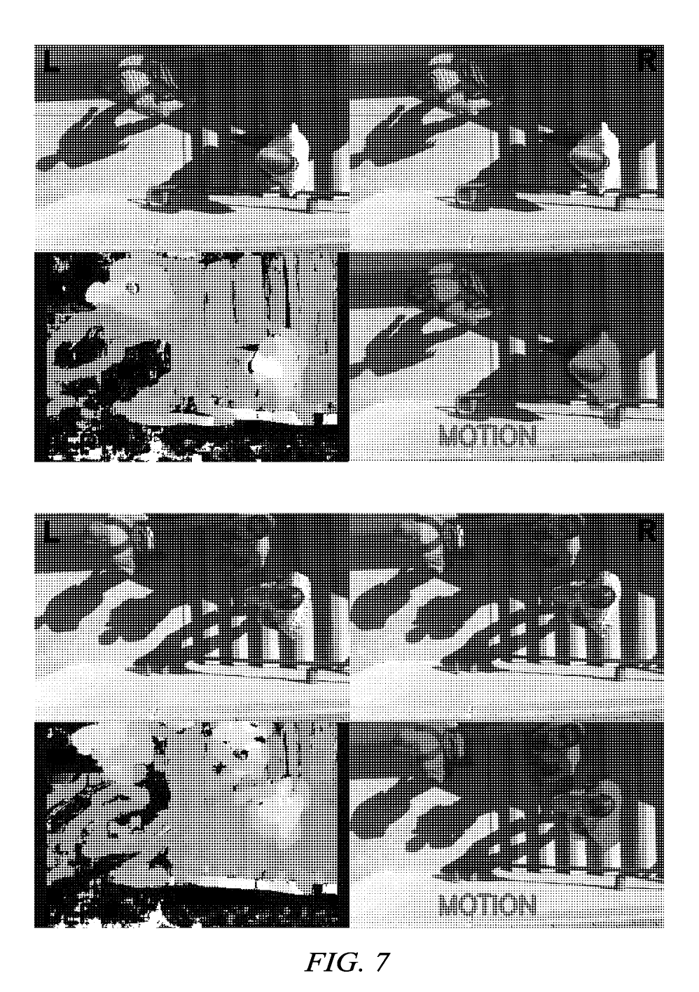

FIG. 1, FIG. 2 and FIG. 3 are embodiments of depth images used to generate warnings in a back-over scenario. FIG. 4, FIG. 5, and FIG. 6 are embodiments of depth images used to generate warnings in front-looking proximity scenarios. Each of these figures shows left and right stereo image pairs. The depth image as computed by the stereo vision module is displayed in false color at the bottom left: bright-yellow means very close to the camera, dark red means far away from the camera, and the shades of orange encode various levels of depth in between. The warning graphics is shown at the bottom right. In all the Figures, the warning graphics delineate those pixels in the scene that belong to nearby objects that are deemed to represent potential danger. FIG. 7 is an embodiment of depth images used to generate warnings in a video security scenario. Applying the depth analysis to a video security scenario, motion is detected reliably. For example, as seen in FIG. 7, people are detected from a ceiling camera, looking top-down on an outdoor staircase. The motion is detected utilizing a stereo camera and depth analysis to provide a reliable detection of “motion” in the scene. The cast shadows are properly ignored and the moving people are properly detected.

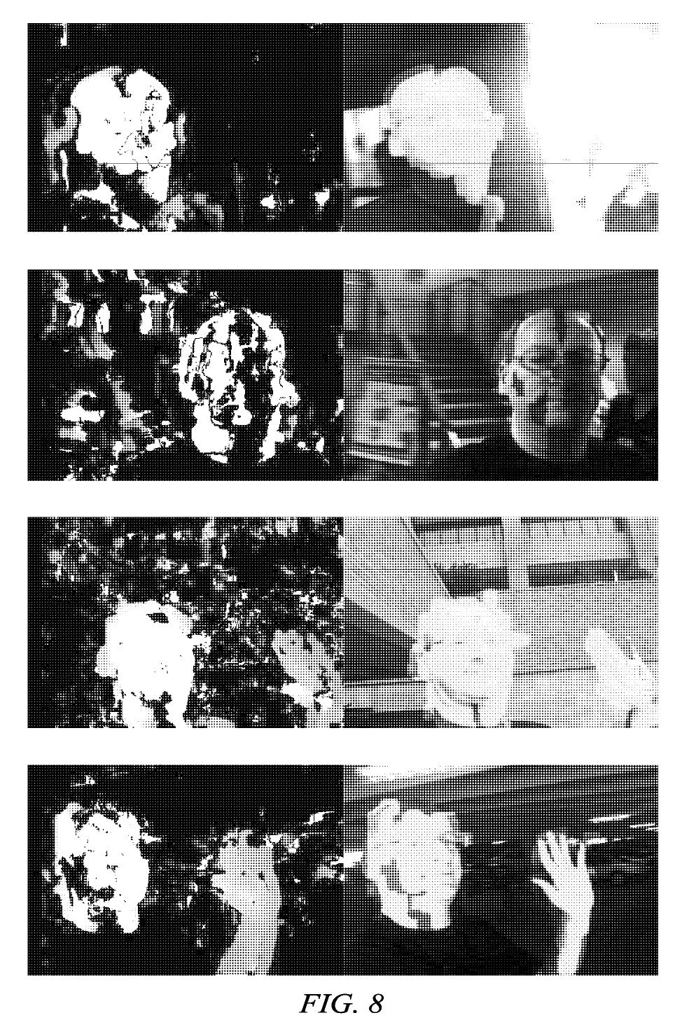

FIG. 8 is an embodiment of depth images used in Human Device Interface for gesture based interaction. As shown in FIG. 8, when detecting gesture-based interactions, the depth detection provides a robust segmentation of a user's head, arm or hand as shown below. Thus, utilizing stereo depth images for proximity sensing properly detects objects and successfully suppresses the ground plane Stereo vision is a passive sensing modality that is cost effective compared to active methods.

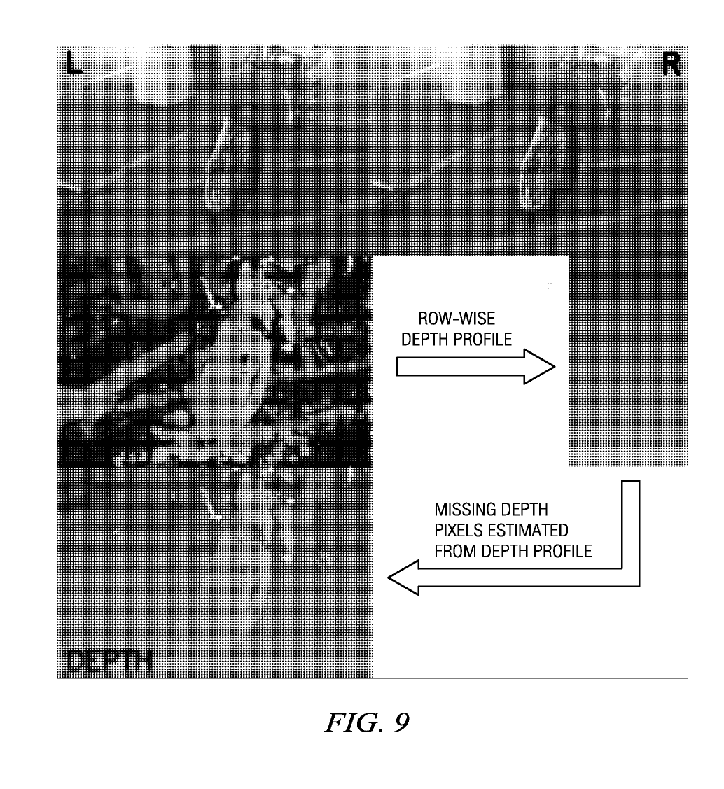

FIG. 9 is an embodiment of images depicting interpolating missing depth pixels with the depth model. In stereo depth images, depth model underlying proximity warning are usually helpful in interpolation, holes fill in, missing measurements and the likes. In today's stereo technology, one normally pays a huge computational price to get a dense depth image. Due to computational budget for resolving ambiguities in an image, computationally efficient solutions tend to exhibit depth holes. Shown in FIG. 9 is a depth model that fills-in missing pixels, which results in a dense depth image, and a very plausible one.

In FIG. 9, the middle-row-left image is showing an example of today's low-complexity depth image. In the middle-left-row, the holes are shown as the black pixels. The top row shows the left and right images captured by a stereo camera. The row-wise depth profile is integral to the invention, which is the background depth model. The middle-row-right depicts the model for such a scene. The block arrow applies the model to the imperfect depth image. Accordingly, the application of the depth model.

Thus, the background model row may be retrieved there exits missing depth pixel. By filling the holes with the above process, the middle-row-left image is converted into bottom-row-left image.

The proposed solution works very reliably under adverse imaging conditions, performs robustly indoors and outdoors, including low-light conditions, and works well even if the depth image is not perfect and/or dense. Hence, this solution is a low-complexity solution that is capable of running in real-time. In addition, the proposed solution does not need to known a priori the class/shape/appearance of an object to be able detect it.

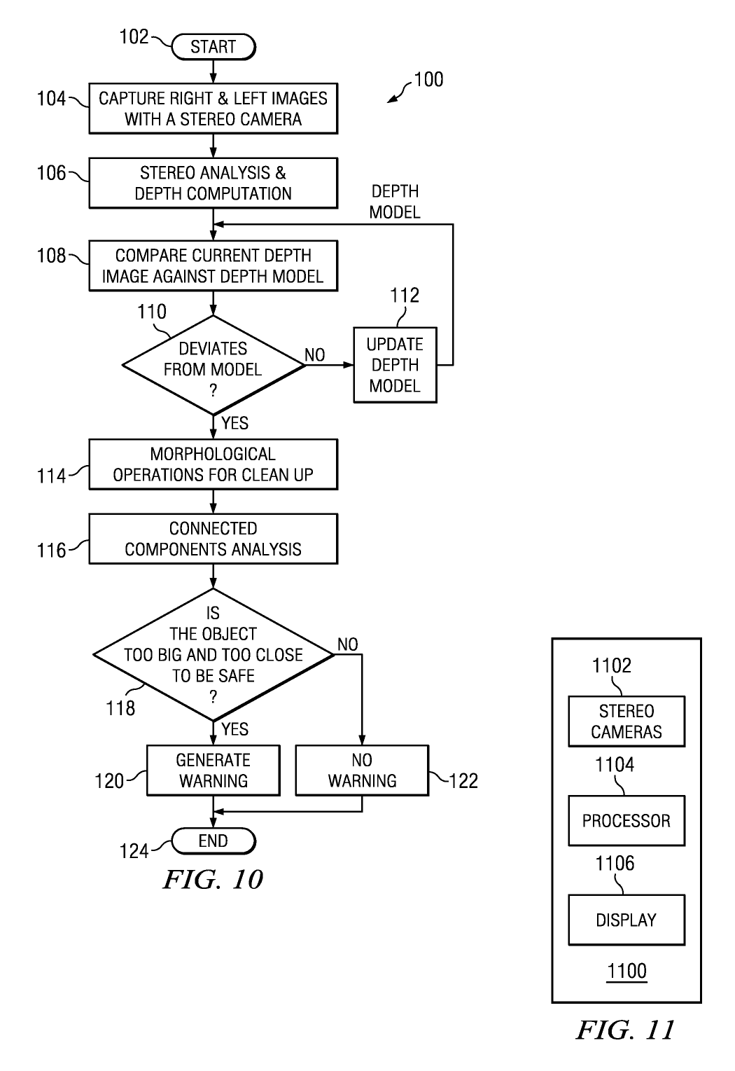

FIG. 10 is an embodiment of a flow diagram for a method 100 for operating a stereo-based proximity warning system for vehicle safety. The method 100 starts at step 102 and proceeds to step 104. At step 104, the method 100 captures a right and a left image utilizing the right and left stereo cameras. At step 106, the method 100 performs stereo analysis and depth computation. At step 108, the method 100 compares the current depth image with the depth model.

At step 110, the method 100 determines if the analysis shows a deviation from the model. If there is no significant deviation, the method 100 proceeds to step 112, wherein the depth model is updated and proceeds to step 108. Otherwise, the method 100 proceeds to step 114, wherein the method 100 performs the morphological operations for clean-up and proceeds to step 116. At step 116, the method 100 performs a connected components analysis. At step 118, the method 100, utilizing the component analysis, determines of the object is too close to be safe. If it is too close, then the method 100 proceeds to step 120, wherein a warning is generated on a display and proceeds to step 124. If it is not too close, then the method 100 proceeds to step 122, wherein no warning is issued and proceeds to step 124. The method 100 ends at step 124.

FIG. 11 is an embodiment of a block diagram for a stereo-based proximity warning system 1100 for vehicle safety. The stereo-based proximity warning system 1100 maybe mounted on a vehicle. The stereo-based proximity warning system 1100 comprises a stereo camera 1102, a processor 1104 and a display 1106. The stereo camera 1102 includes two or more cameras. The various cameras maybe capable of synchronizing with each other to avoid temporal aliasing. The stereo camera 1102 is capable of capturing various angles of the same object. The processor 1104 communicates with the stereo cameras and/or the display 1106. The stereo-based proximity warning system 1100 performs the method for operating a stereo-based proximity warning system, discussed below.

While the foregoing is directed to embodiments of the present invention, other and further embodiments of the invention may be devised without departing from the basic scope thereof, and the scope thereof is determined by the claims that follow.

What is claimed is:

1. A method for stereo-based proximity warning system for vehicle safety, comprising:
capturing a right and a left image utilizing the right and left of stereo cameras;
performing stereo analysis and depth computation for comparing and determining the depth deviation between the current depth image with the depth model;
updating the depth model when there is minimal or no deviation, otherwise, performing morphological operations for clean-up and connected components analysis; and
determining if the object is too close to be safe utilizing the component analysis;
and generating a warning when the object is too close.

2. The method of claim 1, wherein the warning is displayed on a display.

3. A apparatus for stereo-based proximity warning system for vehicle safety, comprising:
means for capturing a right and a left image utilizing the right and left of stereo cameras;
means for performing stereo analysis and depth computation for comparing and determining the depth deviation between the current depth image with the depth model;
means for updating the depth model utilized when there is minimal or no deviation and means for performing morphological operations for clean-up and connected components analysis utilized otherwise; and
means for determining if the object is too close to be safe utilizing the component analysis; and generating a warning when the object is too close.

4. The apparatus of claim 3, wherein the warning is displayed on a display.

5. A non-transitory computer readable storage comprising computer instruction, when executed performs a method for stereo-based proximity warning system for vehicle safety, the method comprising:
capturing a right and a left image utilizing the right and left of stereo cameras;
performing stereo analysis and depth computation for comparing and determining the depth deviation between the current depth image with the depth model;
updating the depth model when there is minimal or no deviation, otherwise, performing morphological operations for clean-up and connected components analysis; and
determining if the object is too close to be safe utilizing the component analysis;
and generating a warning when the object is too close.

6. The non-transitory computer readable storage of claim 5, wherein the warning is displayed on a display.
